(19) United States
(12) Patent Application Publication
(10) Pub. No.: US 2014/0088884 A1
(43) Pub. Date: Mar. 27, 2014

(54) METHODS OF SOURCE ATTRIBUTION FOR CHEMICAL COMPOUNDS

(71) Applicant: Battelle Memorial Institute, (US)

(72) Inventors: David A. Friedenberg, Worthington, OH (US); Theodore P. Klupinski, Grandview Heights, OH (US); Douglas D. Mooney, Columbus, OH (US); Erich D. Strozier, Westerville, OH (US); Cheryl A. Dingus, Columbus, OH (US); Eugene Anthony Zarate, Powell, OH (US)

(73) Assignee: Battelle Memorial Institute, Columbos, OH (US)

(21) Appl. No.: 13/886,882

(22) Filed: May 3, 2013

Related U.S. Application Data
(60) Provisional application No. 61/643,080, filed on May 4, 2012.

(51) Int. Cl. G01N 30/86

(52) U.S. Cl. CPC G01N 30/8686
USPC 702/22

(57) ABSTRACT

Methods of determining the source of an unknown sample are disclosed. Mass spectra from possible sources are obtained using two-dimensional gas chromatography coupled with time-of-flight mass spectrometry. That data is processed to obtain a dataset. A random forest algorithm is used to classify the dataset and create a classifier that distinguishes between the possible sources.

### CROSS-REFERENCE TO RELATED APPLICATIONS

This application claims priority to U.S. Provisional Patent Application Ser. No. 61/643,080, filed on May 4, 2012. The disclosure of that application is hereby fully incorporated by reference in its entirety.

### STATEMENT REGARDING FEDERALLY SPONSORED RESEARCH OR DEVELOPMENT

This invention was made with government support under Contract No. W911W5-07-D-0001 awarded by the U.S. Department of the Army. The United States government has certain rights in the invention.

### BACKGROUND

The present disclosure relates to methods for attributing a sample of a given compound to a specific source. Such methods are also known as fingerprinting, and are useful in many different scenarios, for example in national security applications. There are many applications in which it is desirable to identify the source of a given compound in a sample. For example, it can be helpful to be able to distinguish high-quality food ingredients from low-quality food ingredients that are falsely labeled as the high-quality food ingredient. This type of substitution can create health risks for consumers. This can also be a business concern to vendors of the high-quality ingredient and buyers of the low-quality ingredient.

As another non-limiting example, it may be helpful to be able to determine the source of materials used in criminal activities such as illegal drugs or homemade explosives. Materials seized by one agency could be compared to materials seized by a second agency or materials seized in a different location to determine whether or not the two materials come from the same source.

As a further non-limiting example, one could distinguish between two possible sources of environmental contamination to determine which source is responsible for the contamination.

Accordingly, it is desirable to provide methods for determining the source of a given compound.

### BRIEF DESCRIPTION

The present disclosure relates to methods of processing large quantities of data to determine relationships between different material sources that can allow one to determine from which source a particular sample has come. Briefly, the different material sources are analyzed to create a dataset containing information on the presence and/or relative concentration of chemical compounds in each source. The dataset is then classified using a random forest algorithm to create a classifier that distinguishes between the possible sources. A compound sample can then be analyzed using the classifier to identify the source of the compound sample (i.e. as either being one of the particular material sources, or as coming from none of the particular material sources).

Disclosed herein are methods for attributing a compound sample to a specific source, comprising: evaluating a plurality of possible sources using two-dimensional gas chromatography coupled with time-of-flight mass spectrometry to create a datafile for each source; processing each datafile to obtain a dataset, the dataset containing entries corresponding to the presence or relative concentration of chemical compounds in each possible source; classifying the dataset using a random forest algorithm to create a classifier that distinguishes between the possible sources; and analyzing a datafile of the compound sample using the classifier to identify the source of the compound sample.

The classifier may identify whether a given chemical compound is present or absent for a possible source. Alternatively, the classifier may identify a relative response for a chemical compound for each possible source.

The processing can occur by summing the response of all peaks within an oval area defined by a first-dimension retention time and a second-dimension retention time.

The datafile may contain entries corresponding to the presence and the relative concentration of chemical compounds in each possible source.

Each datafile may be created using an organic solvent.

In specific embodiments, the two-dimensional gas chromatography is performed using a first non-polar column and a second polar column. A diameter of the first column may be greater than a diameter of the second column. A length of the first column may be greater than a length of the second column. One or more modulators may be present between the first column and the second column. A retention time of the first column may be accurate to within 6 seconds. A retention time range of the second column may be about 3 seconds.

Also described herein are methods for creating a classifier that distinguishes between different sources of a given compound, comprising: creating a datafile for each source by separately evaluating the different sources using two-dimensional gas chromatography coupled with time-of-flight mass spectrometry; processing each datafile to obtain a dataset, the dataset containing entries corresponding to the presence or relative concentration of chemical compounds in each of the different sources; and classifying the dataset using a random forest algorithm to create a classifier that distinguishes between the different sources.

The classifier may identify whether a given chemical compound is present or absent for a possible source. Alternatively, the classifier may identify a relative response for a chemical compound for each possible source.

The processing can occur by summing the response of all peaks within an oval area defined by a first-dimension retention time and a second-dimension retention time.

The datafile may contain entries corresponding to the presence and the relative concentration of chemical compounds in each possible source.

Each datafile may be created using an organic solvent.

In specific embodiments, the two-dimensional gas chromatography is performed using a first non-polar column and a second polar column. A diameter of the first column may be greater than a diameter of the second column. A length of the first column may be greater than a length of the second column. One or more modulators may be present between the first column and the second column. A retention time of the first column may be accurate to within 6 seconds. A retention time range of the second column may be about 3 seconds.

These and other non-limiting aspects and/or objects of the disclosure are more particularly described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1 is a schematic diagram of an apparatus for two-dimensional gas chromatography coupled with time-of-flight mass spectrometry (GCxGC-TOFMS).

FIG. 2 is an example of a classification tree.

FIG. 3 is a table showing the three organophosphates and their different sources used for an experiment.

FIG. 4 is a two-dimension chromatogram for a dichlorvos sample generated using (GCxGC-TOFMS).

FIG. 5 is a two-dimension chromatogram for a dicrotophos sample generated using (GCxGC-TOFMS).

FIG. 6 is an illustration of the Oval Area method on a peak of a chromatogram.

FIG. 7 is a confusion table showing the results of pattern recognition using the Oval Area method.

FIG. 8 is a separation table for chlorpyrifos.

FIG. 9 is a separation table for dichlorvos.

FIG. 10 is a separation table for dicrotophos.

FIG. 11 is a partial table showing some of the compounds that were found in the chlorpyrifos samples and their presence or absence from each source.

FIG. 12 is a bar graph showing the proportion of trees voting for a given source of a blind sample.

FIG. 13 is a flowchart illustrating the methods of the present disclosure.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function. In the following specification and the claims which follow, reference will be made to a number of terms which shall be defined to have the following meanings.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

Presented herein are methods and approaches for attributing a sample containing volatile or semi-volatile organic chemical compounds to a specific source. This can be done according to the presence/absence and/or relative concentrations of the chemical compounds in samples obtained from the various possible sources. The present disclosure contemplates the use of two-dimensional gas chromatography coupled with time-of-flight mass spectrometry (GCxGC-TOFMS) as a chemical analysis technique. The data obtained using this chemical analysis technique is then analyzed using a random forest algorithm as a statistical pattern recognition technique.

Generally, datafiles are created by evaluating a plurality of samples from possible sources using GCxGC-TOFMS (i.e. one datafile for each sample). Each datafile is then processed to create a dataset that provides various representations of the datafiles. The dataset is then classified using a random forest algorithm to create a classifier that distinguishes between the possible sources. The sample can then be compared to the classifier to identify the specific source of the sample.

Two-dimensional gas chromatography coupled with time-of-flight mass spectrometry (GCxGC-TOFMS) offers substantially greater component separation and identification capability than other traditional analytical chemistry techniques. Gas chromatography is also especially well-suited for analyzing mixtures of volatile and semi-volatile compounds. Generally, an organic solvent such as acetone should be used.

Two-dimensional gas chromatography employs two gas chromatography columns instead of only one such column. A sample is injected into a first column, and the eluent from the first column is then injected onto a second column. The second column has a different separation mechanism. For example, in some embodiments herein, the first column is a non-polar column and the second column is a polar column. Other variations are also possible, such as running the two columns at different temperatures. The second column should run much faster than the first column. Put another way, the retention time on the first column should be greater than the retention time on the second column. One or more modulators are located between the first column and the second column. The modulator acts as a gate or interface between the two columns, and controls the flow of analytes from the first column to the second column.

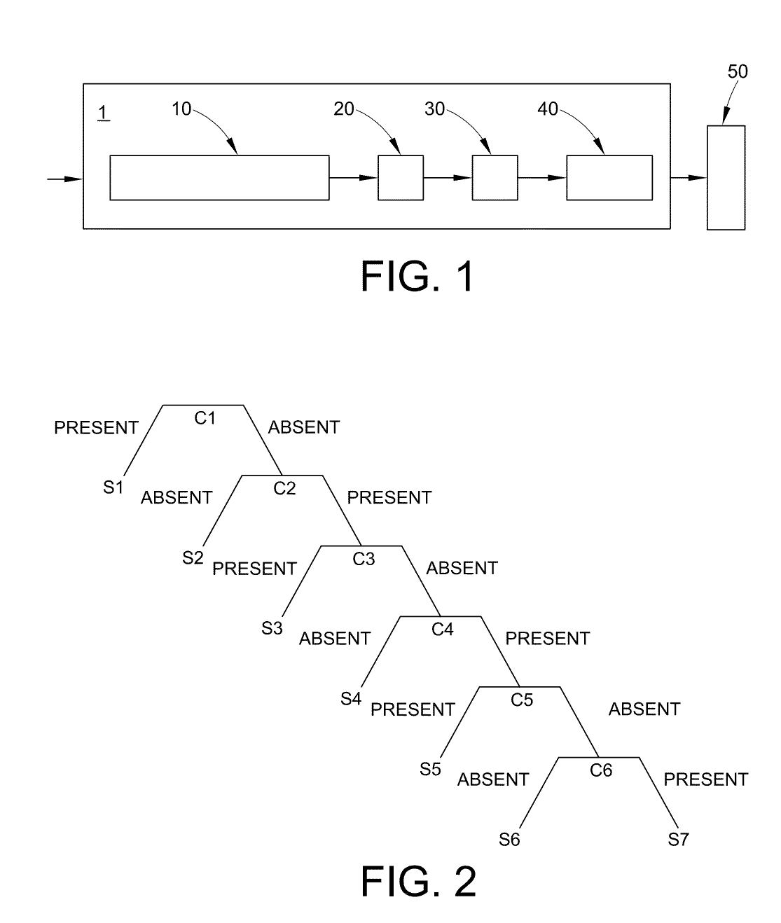

FIG. 1 shows a schematic using a gas chromatograph (GC) 1 equipped with one type of two-stage modulator. Generally, the first modulator stage 20 operates by trapping/immobilizing eluent from the first dimension GC column 10 in place. This collected eluent is periodically released to the second modulator stage 30. The second modulator stage 30 releases the eluent as a narrow band into the second dimension GC column 40 to start the secondary separation. The first modulator stage 20 and the second modulator stage 30 are out of phase with each other, so that the first column 10 and the second column 40 are isolated from each other. The eluent from the second column is sent to the time-of-flight mass spectrometer 50 for analysis. The resulting output can be represented as a three-dimensional graph, with the first column retention time on the x-axis, the second column retention time on the y-axis, and the signal intensity on the z-axis. When two-dimensional gas chromatography methods are carefully designed, they can provide substantial increases in chromatographic separation in comparison with single-dimension gas chromatography techniques. The separation of chemical components by two mechanisms (e.g., by boiling point in the first dimension, and by polarity in the second dimension) expands the chromatographic space in which compounds can be separated from one another and thus increases the ability to resolve trace-level compounds that may otherwise be obscured.

Time-of-flight mass spectra can be acquired at very high rates with sensitivity approaching quadrupole selective ion monitoring (SIM), but have the advantage of being collected in full-scan mode. The full-scan mass spectra can be matched against library spectra to provide tentative identifications of unknown compounds in the absence of analytical standards. They also allow for the use of deconvolution software to further separate interfering or overlapping component peaks.

The data collected from the GCxGC-TOFMS for the multiple samples is referred to herein as a dataset. Generally speaking, the dataset contains many peaks, and for each peak has the sample from which the peak was measured, the retention time on the first column, the retention time on the second column, and the signal intensity for each of up to 996 ion channels. The dataset may contain several hundred to several thousand peaks.

The information in the dataset can be used to tentatively identify a chemical compound for each peak, for example by comparing the information to a mass spectral reference library. In addition, the peaks in the dataset can be filtered to remove known artifacts, such as column siloxane bleed and injection solvent. This information can then be arranged in different ways. For example, one way is to create a list of all compounds identified across all samples and then, for each sample, tabulate whether a given compound is present or absent. These variables are referred to as “In/Out” variables.

Another approach can be used to account for the fact that a single chemical compound may sometimes exhibit multiple peaks, especially if present at a high concentration. In this regard, the first-dimension retention time (i.e. the retention time of the first column) is typically very long. The second-dimension retention time (i.e. the retention time of the second column) is typically very short, for example around three seconds. The first-dimension retention time is generally accurate to within six seconds. Strong peaks are typically represented across much of the second-dimension retention time. To accommodate this expected analytical variability, for a particular compound, the retention time pair corresponding to the largest peak can be located. A rectangle can then be drawn around this peak, and the sum of all peaks for the same compound found within six seconds of the base first-dimension retention time and within the second-dimension retention time are added together. In other words, all peaks within a rectangle 12 seconds wide by 3 seconds tall are summed together. In practice, the distribution of peaks within this rectangle often has a roughly oval shape, and the variables created using this summing approach can be referred to as “Oval Area” variables. This analysis also allows for a compound that may be present from multiple sources but at different levels. This also filters extra peaks due to peak tailing or column overload. Evaluation can be done by the difference in mean oval area for two groups divided by the pooled variance.

As a result, a dataset can be created that contains entries corresponding to the presence of chemical compounds in each possible source (when e.g. In/Out variables are calculated) or that contains entries corresponding to the relative concentration of chemical compounds in each possible source. The various steps that are taken to convert the GCxGC-TOFMS datafiles into this dataset are referred to herein as “processing”.

Next, the dataset is classified using the random forest algorithm to create a classifier that distinguishes between the possible sources of the sample. The random forest algorithm, particularly the Balanced Random Forest algorithm, when applied to GCxGC-TOFMS, provides unique advantages in the ability to attribute a given sample of a known material to a specific source, such as a specific manufacturer or a specific synthesis route. Random Forest classification techniques are especially well suited for data sets with many variables and few observations because they do not require initial variable reduction and do not over-fit the data.

The random forest algorithm is described in Breiman, L., “Random Forests”, Machine Learning, Vol. 45, No. 1, pp. 5-32 (2001). Generally, many classification trees are used to classify observations into groups using a set of predictor variables. Each tree is created using a randomly selected subset of the data with the added restriction that only a subset of possible predictor variables can be used at each split in the tree. By using only some of the data and some of the predictor variables in each tree, the forest will consist of a large number of different trees. FIG. 2 illustrates an example of a classification tree. Here, data has been collected for samples from seven different sources which are labeled S1 through S7. For each source, a dataset has been created that indicates the presence or absence of six different compounds which are labeled C1 through C6. At each node, one of the compounds is used to split up the sources based on the presence/absence of the compound. The splits continue until all samples are classified. Here, in FIG. 2 for example, starting at the top, if compound C1 is present in the sample, then the sample came from source S1. If C1 and C2 are absent, then the sample came from source S2. This example of a classification tree shows one way to perfectly separate the data, though there may be others.

In general, a single classification tree will often fail to completely capture all of the available information concerning which compounds can distinguish between different sources. The random forest algorithm is an ensemble approach that uses multiple classification trees, with the ensemble “voting” for the final classification of a given sample, as well as indicating the relative importance of each compound to the overall algorithm. Each tree is built from a random sample of the data in the dataset. Generally, the random forest algorithm can be described as follows.

The total number of entries in the dataset is N. Each tree receives n entries randomly selected with replacement from the dataset. The number of variables in the dataset is M. A number m of input variables are used to determine the decision at a node. The number m should usually be much lower than M. At each node, randomly select the variables on which to base the decision at that node, and calculate the best split based on those variables. The tree is fully grown until the entries are fully separated. The quality of prediction of this tree can then be estimated by using the tree to predict the classification of the remaining entries in the dataset.

To classify a sample using the Random Forest, each tree in the forest classifies the sample independently and votes for the predicted classification. The Random Forest classification is the classification for which the most trees voted. If the sample being classified was in the data set used to create the tree, only trees that did not use that sample get to vote. This ensures a degree of cross-validation.

In particular embodiments, a balanced random forest algorithm is used. This is a variation on the random forest algorithm, where a stratified random sample is used for each tree instead of a simple random sample. In a stratified random sample, the entries in the dataset are divided into smaller groups known as strata based on shared attributes or characteristics. A random sample from each stratum is taken. In a balanced random forest (BRF), each source has its own stratum, and each tree sees a random sample of the same size from each stratum regardless of the relative sizes of the strata in the overall dataset. This can be beneficial in cases where one stratum may be more prevalent in the dataset than another, a situation often referred to as unbalanced classes. In some cases, especially with small sample sizes, unbalanced datasets can lead to classifiers that are biased towards the largest class. The balanced random forest algorithm can be employed to mitigate this effect. The balanced random forest ensures, in other words, that all of the possible different sources are equally represented in every tree of the forest.

The results obtained from classifying the dataset using the random forest algorithm is referred to herein as a classifier. The classifier contains information that permits one to identify the specific source of a known compound when an unknown sample is analyzed. The classifier can also be described as providing rules that can be used to decide from what source an unknown sample came from. Such rules may be simple or complicated. For example, again referring to FIG. 2, the classifier may identify whether a given compound is present or absent for a possible source. The unknown sample is usually analyzed using GCxGC-TOFMS and then processed as described above, so the resulting information can be compared to the classifier to identify the specific source of the unknown sample.

The methods described above can be used to form a reference classifier that will allow the specific source of an unknown sample to be determined. Put another way, the methods can be used to create a classifier that distinguishes between different sources of a given compound. An unknown compound can also be attributed to a specific source within the dataset or can be identified as not matching any of the sources in the dataset.

The methods of the present disclosure can be useful in the attribution of a chemical compound to a specific source. This approach is useful in several applications, such as chemical forensic analysis of a chemical threat agent, including chemical weapons, or for source attribution, or determination of attribution signatures.

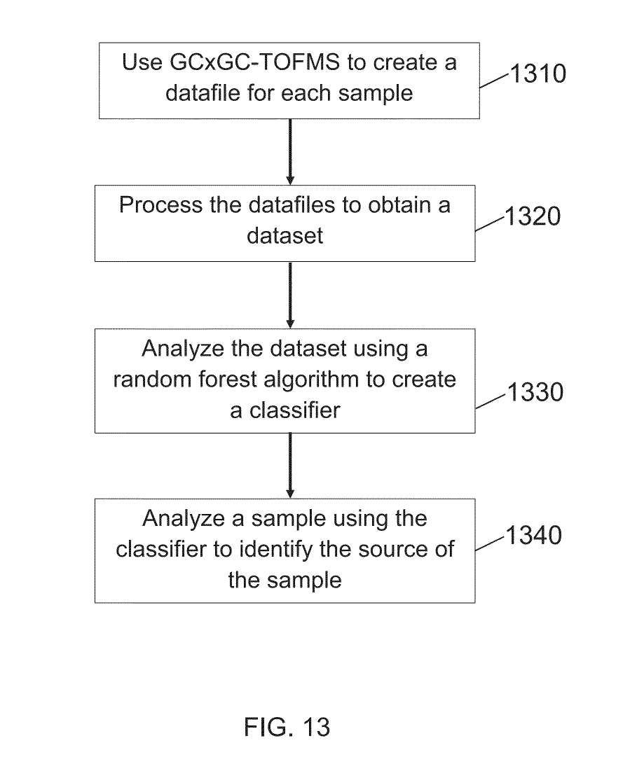

FIG. 13 is a flowchart illustrating the methods of the present disclosure. In step 1310, two-dimensional gas chromatography coupled with time-of-flight mass spectrometry is used on multiple sources to create a datafile for each source. In step 1320, the datafiles are processed to obtain a dataset. The dataset contains entries corresponding to the presence and/or relative concentration of chemical compounds in each of the sources. Next, in step 1330 the dataset is classified using a random forest algorithm to create a classifier that distinguishes between the sources. Finally, in step 1340, a datafile of the compound sample is then analyzed using the classifier to identify the specific source of the compound sample. The specific source will either be one of the sources used to create the dataset, or the system will state that the source is not one of those in the dataset.

The methods of the present disclosure may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the methods described herein, can be used. The methods of the present disclosure are generally implemented by a computer system having a processor, by execution of software processing instructions which are stored in memory. The computer system may include a computer server, workstation, personal computer, combination thereof, or any other computing device. The computer system may further include hardware, software, and/or any suitable combination thereof, configured to interact with an associated user, a networked device, networked storage, remote devices, or the like. The processor may also control the overall operations of the computer system and other components, such as the GCxGC-TOFMS apparatus of FIG. 1.

The computer system may also include one or more interface devices for communicating with external devices or to receive external input, such as a computer monitor, a keyboard or touch or writable screen, a mouse, trackball, or the like, for communicating user input information and command selections to the processor. The various components of the computer system may be all connected by a data/control bus.

The memory used in the computer system may represent any type of non-transitory computer readable medium such as random access memory (RAM), read only memory (ROM), magnetic disk or tape, optical disk, flash memory, or holographic memory. In some embodiments, the memory is a combination of random access memory and read only memory. The processor and memory can be combined in a single chip. Other mass storage device(s), for example, magnetic storage drives, a hard disk drive, optical storage devices, flash memory devices, or a suitable combination thereof, can also be used to provide the memory. The memory is also used to store the data processed in the method as well as the instructions for performing the exemplary method.

The digital processor can be, for example, a single core processor, a dual core processor (or more generally a multiple core processor), a digital processor and cooperating math coprocessor, a digital controller, or the like. The digital processor executes instructions stored in memory 108 for performing the methods outlined above.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in a storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The methods illustrated in may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the methods may be implemented in transitory media, such as a transmittable carrier wave in which the control program is embodied as a data signal using transmission media, such as acoustic or light waves, such as those generated during radio wave and infrared data communications, and the like.

The following example is for purposes of further illustrating the present disclosure. The example is merely illustrative and is not intended to limit the methods of the present disclosure to the materials, conditions, or process parameters set forth therein.

### Example

Organophosphate pesticides (OPP) are a group of highly toxic compounds that are widely available in many countries and may be attractive as a chemical weapon to, for example, terrorists or criminal elements. In this regard, compounds other than the parent OPP, such as manufacturing precursors, byproducts, or degradation products are often present in commercial preparations and can thus provide a fingerprint for a source of the OPP.

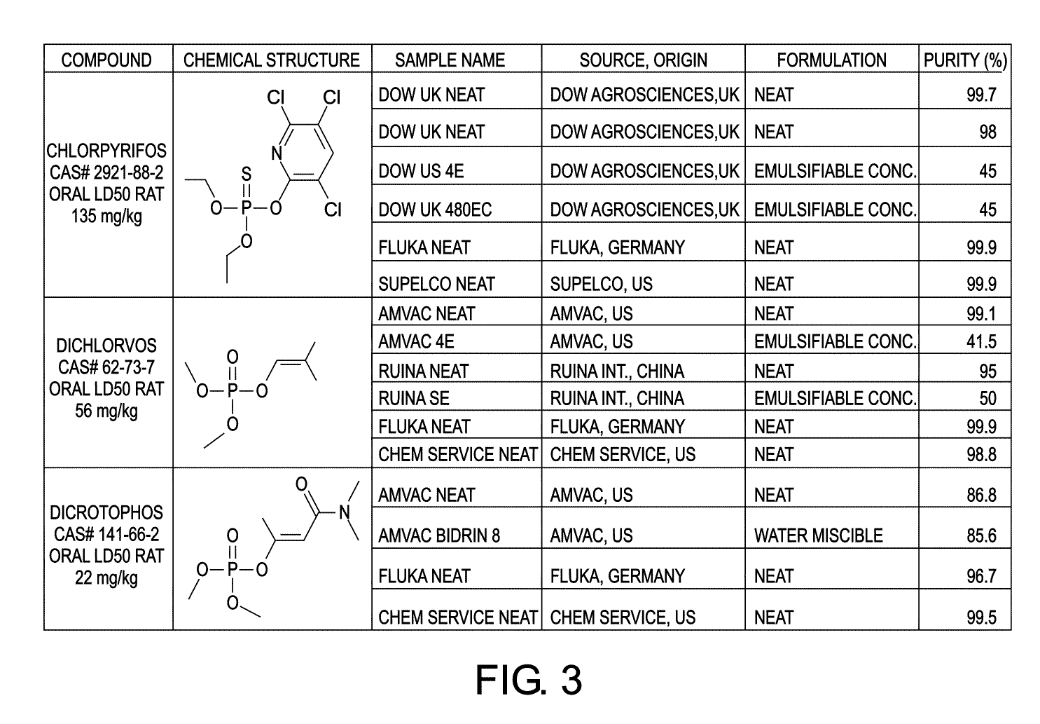

Three different OPPs were used in the experiment. Those three OPPs were chlorpyrifos (CAS#2921-88-2), dichlorvos (CAS#62-73-7), and dicrotophos (CAS#141-66-2). Each OPP had four to six different sources, as shown in FIG. 3. For each source, 10 replicates (i.e. samples) were used to characterize variability, each diluted in acetone. 10 replicates of acetone were also used and designated as “solvent blank” for a control.

Two-dimensional gas chromatography coupled with time-of-flight mass spectrometry (GCxGC-TOFMS) was used to evaluate all of the replicates. A LECO Pegasus III system with two-stage thermal modulation was used. The first column was a non-polar column (DB-1, 30 meters length, 0.25 mm inner diameter, 1.0 μf), and the second column was a polar/aromatic column (BPX-50, 1.0 meter length, 0.1 mm inner diameter, 0.1 μf). LECO ChromaTOF® software was used for peak detection and spectral deconvolution.

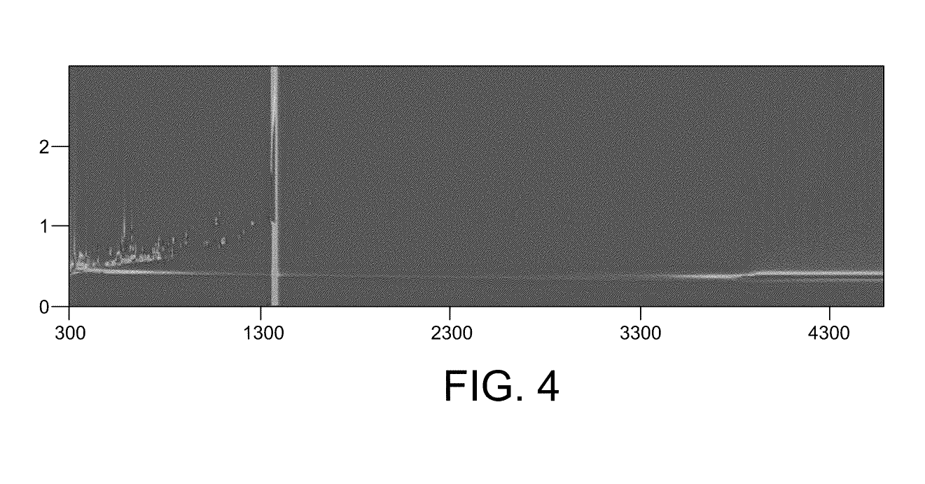

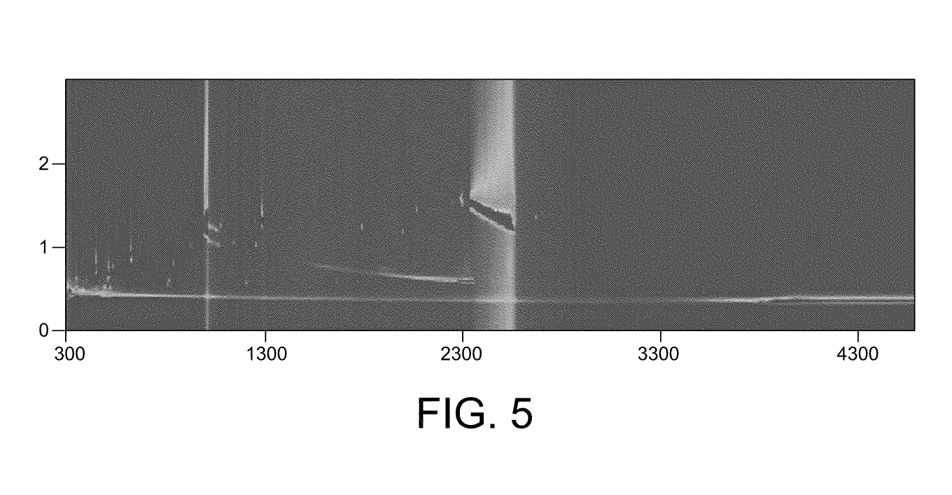

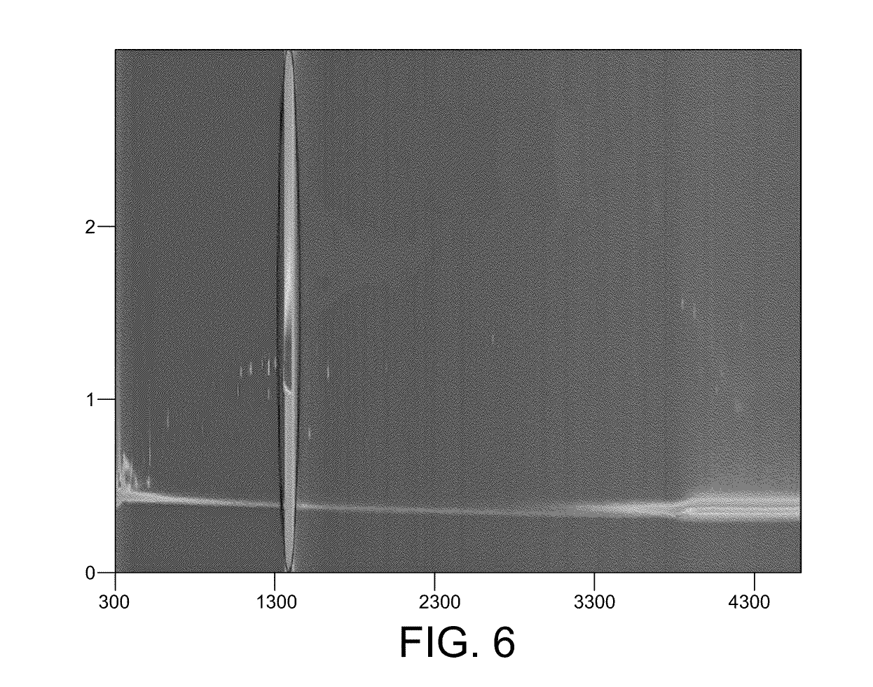

FIG. 4 is a resulting two-dimensional chromatogram for a dichlorvos sample. FIG. 5 is a resulting two-dimensional chromatogram for a dicrotophos sample. The colors indicate the relative intensity.

The data was then processed in two ways (In/Out and Oval Area). FIG. 6 is an illustration of the Oval Area Method for dichlorvos, and is a magnified portion of FIG. 4. Peaks that occur outside of ±6 seconds of the maximum response in the first dimension are ignored. The oval area is drawn here around the largest peak.

Compounds for the peaks were tentatively identified by automated matching of the mass spectra with the National Institutes of Standards and Technology (NIST) 05 Mass Spectral Library. The samples contained from about 700 to over one thousand compounds, depending on the source material. The acetone blanks contained about 500 compounds. Many of these compounds were not identified by the automated matching.

The Balanced Random Forest algorithm was used to create a classifier that could distinguish between the different sources. Table 1 below summarizes the percentage of successful classification for each OPP compound based on the two processing methods. 87% to 100% accuracy was obtained. The data for chlorpyrifos was reduced due to missing data.

TABLE 1
% Successful Classification by Random Forests

| Compound | % In/Out | % Oval Area |
|---|---|---|
| Chlorpyrifos | 87 (weighted) | 97 (weighted) |
| Dichlorvos | 100 | 100 |
| Dicrotophos | 100 | 100 |

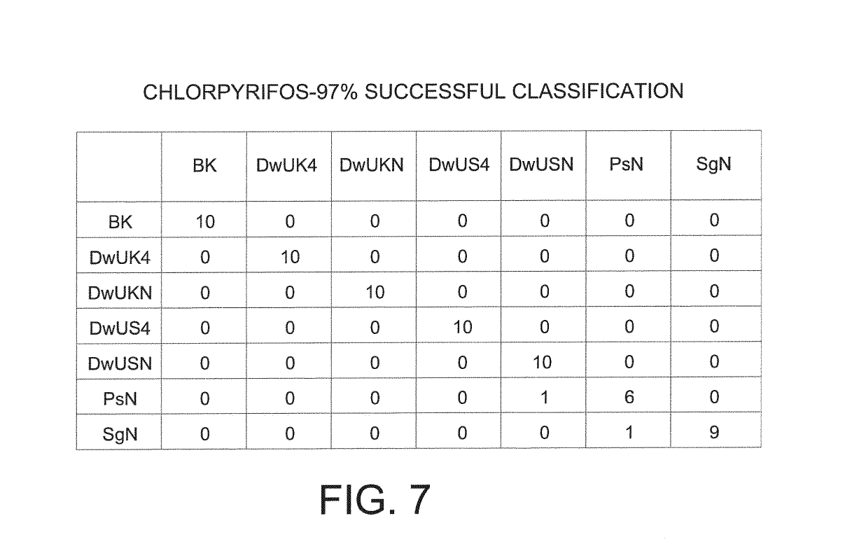

FIG. 7 is a confusion table showing the results of pattern recognition using the Oval Area dataset. “BK” refers to the solvent blanks. 97% of the samples were correctly classified. The rows are the true samples, and the columns are the predicted source. For example seven samples from the source PsN were analyzed. The classifier predicted that six of the samples came from the source PsN, and one of the samples came from the source DwUSN.

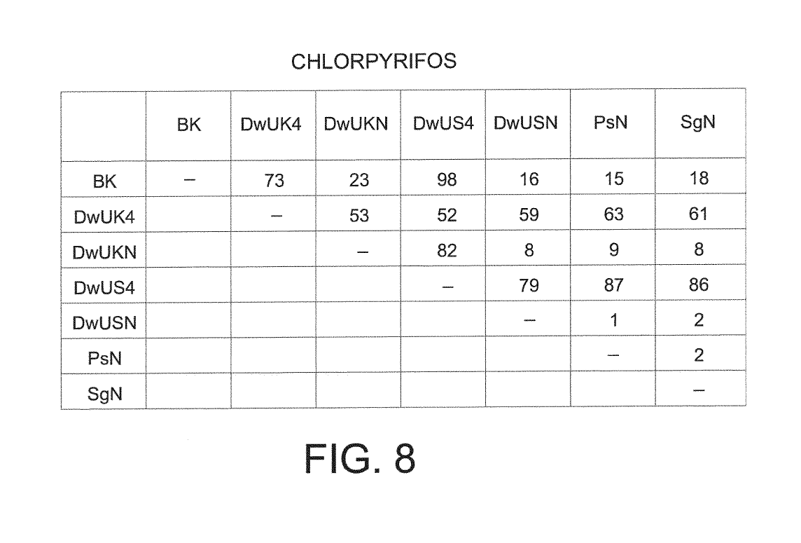

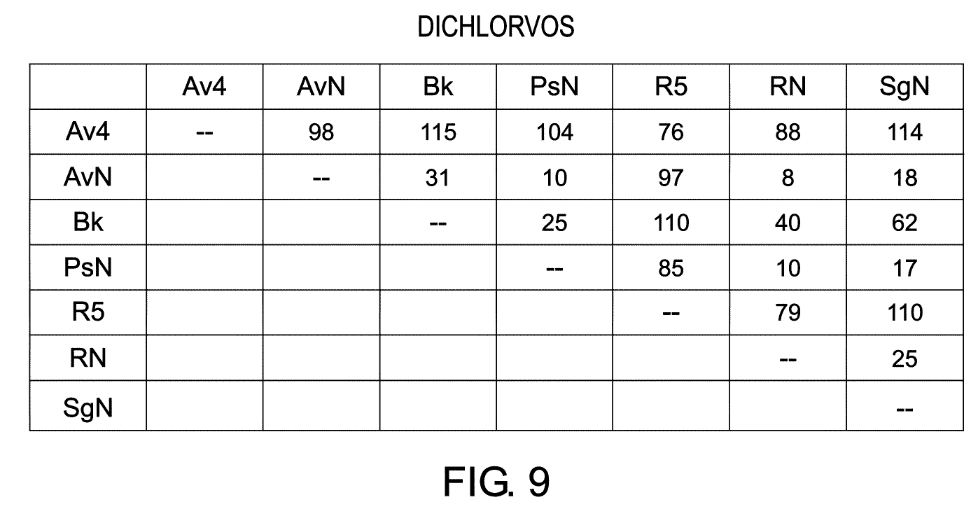

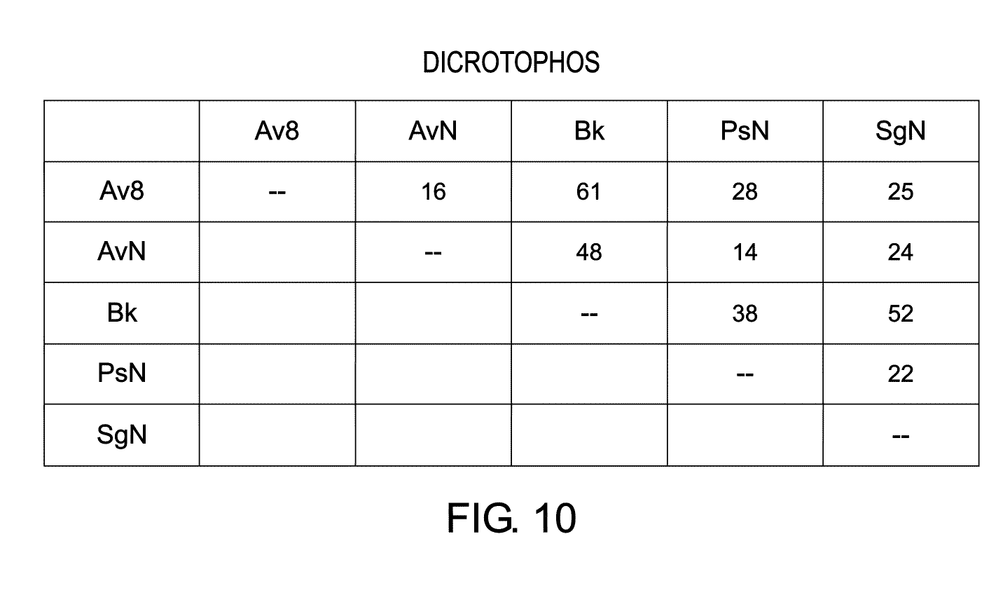

FIG. 8 is a separation table for chlorpyrifos. This table shows the number of compounds that will perfectly separate two source materials. Each compound is found in all samples from one source and in no samples from the other source. FIG. 9 is a separation table for dichlorvos, and FIG. 10 is a separation table for dicrotophos.

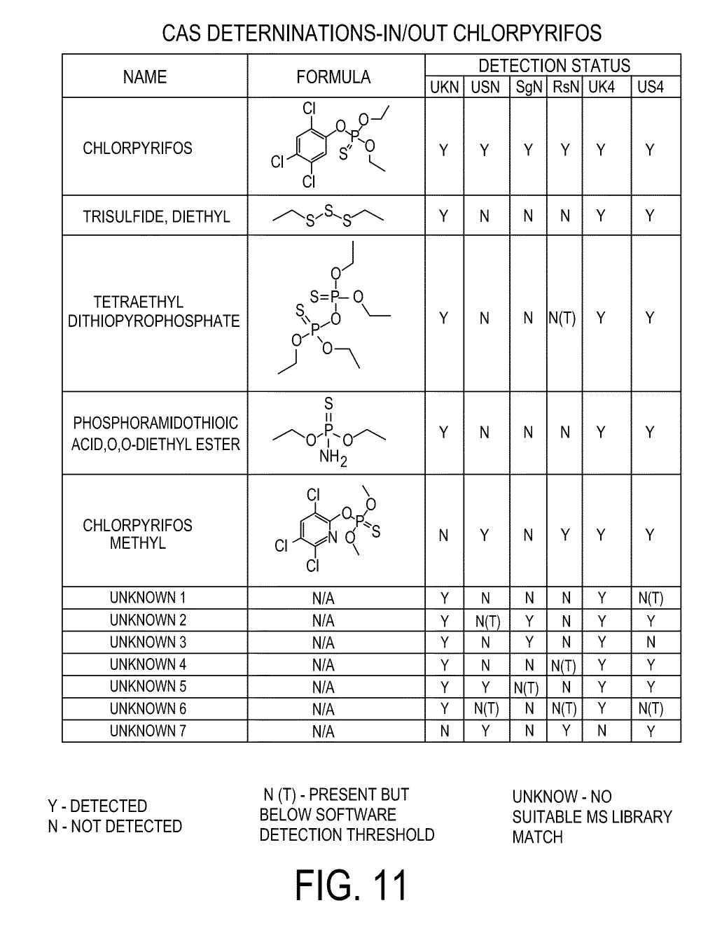

FIG. 11 is a partial table showing some of the compounds that were found in the chlorpyrifos samples and their presence or absence from each source.

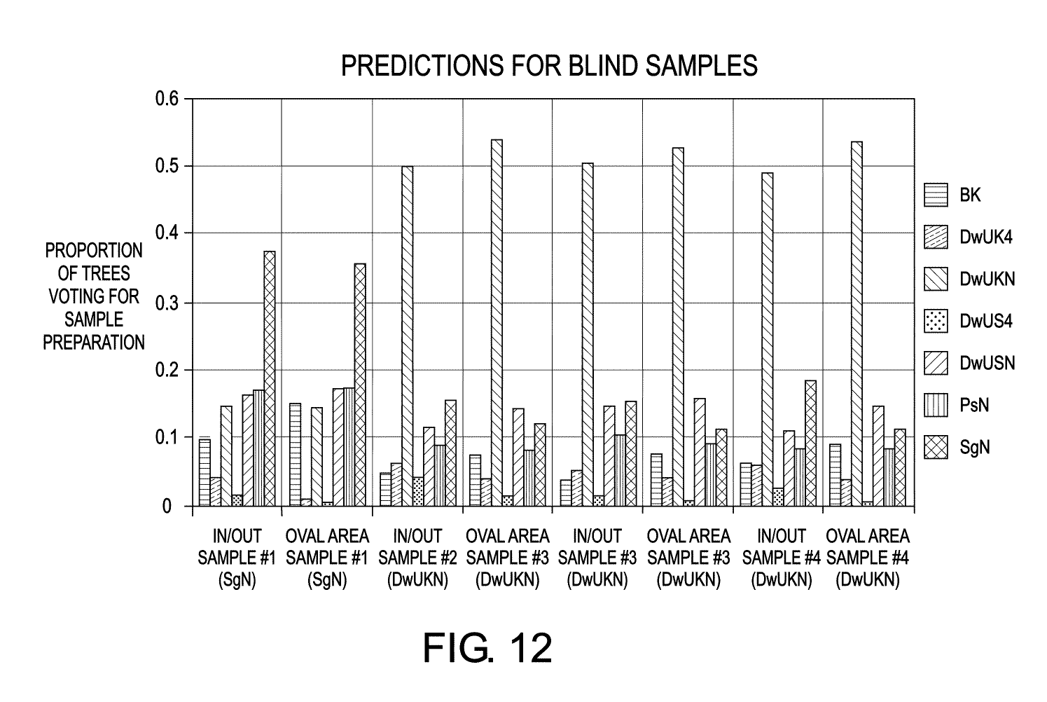

Next, four “blind” samples were evaluated using the classifier. FIG. 12 is a graph showing the four samples. The x-axis indicates the method (In/Out or Oval Area) and the true identity of the sample. The y-axis indicates the proportion of trees voting for each source of the sample. As seen in the graph, for Sample #1, the majority of trees using the In/Out method voted for the source as being SgN. This was correct. All of the blind samples were correctly identified by the classifier.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A method for attributing a compound sample to a specific source, comprising:
evaluating a plurality of possible sources using two-dimensional gas chromatography coupled with time-of-flight mass spectrometry to create a datafile for each source;
processing each datafile to obtain a dataset, the dataset containing entries corresponding to the presence or relative concentration of chemical compounds in each possible source;
classifying the dataset using a random forest algorithm to create a classifier that distinguishes between the possible sources; and
analyzing a datafile of the compound sample using the classifier to identify the source of the compound sample.

2. The method of claim 1, wherein the classifier identifies whether a given chemical compound is present or absent for a possible source.

3. The method of claim 1, wherein the classifier identifies a relative response for a chemical compound for each possible source.

4. The method of claim 1, wherein the processing occurs by summing the response of all peaks within an oval area defined by a first-dimension retention time and a second-dimension retention time.

5. The method of claim 1, wherein the datafile contains entries corresponding to the presence and the relative concentration of chemical compounds in each possible source.

6. The method of claim 1, wherein each datafile is created using an organic solvent.

7. The method of claim 1, wherein the two-dimensional gas chromatography is performed using a first non-polar column and a second polar column.

8. The method of claim 7, wherein a diameter of the first column is greater than a diameter of the second column.

9. The method of claim 7, wherein a length of the first column is greater than a length of the second column.

10. The method of claim 7, wherein one or more modulators is present between the first column and the second column.

11. The method of claim 7, wherein a retention time of the first column is accurate to within 6 seconds.

12. The method of claim 7, wherein a retention time range of the second column is about 3 seconds.

13. A method for creating a classifier that distinguishes between different sources of a given compound, comprising:
creating a datafile for each source by separately evaluating the different sources using two-dimensional gas chromatography coupled with time-of-flight mass spectrometry;
processing each datafile to obtain a dataset, the dataset containing entries corresponding to the presence or relative concentration of chemical compounds in each of the different sources; and
classifying the dataset using a random forest algorithm to create a classifier that distinguishes between the different sources.

14. The method of claim 13, wherein the classifier identifies whether a given chemical compound is present or absent for each source.

15. The method of claim 13, wherein the classifier identifies a relative response for a chemical compound for each source.

16. The method of claim 13, wherein the processing occurs by summing the response of all peaks within an oval area defined by a first-dimension retention time and a second-dimension retention time.

17. The method of claim 13, wherein the dataset contains entries corresponding to the presence and the relative concentration of chemical compounds in each source.

18. The method of claim 13, wherein each datafile is created using an organic solvent.

19. The method of claim 13, wherein the two-dimensional gas chromatography is performed using a first non-polar column and a second polar column.

20. The method of claim 19, wherein a diameter of the first column is greater than a diameter of the second column.

21. The method of claim 19, wherein a length of the first column is greater than a length of the second column.

22. The method of claim 19, wherein one or more modulators is present between the first column and the second column.

23. The method of claim 19, wherein a retention time of the first column is accurate to within 6 seconds.

24. The method of claim 19, wherein a retention time range of the second column is about 3 seconds.
